(19) United States
(12) Patent Application Publication
(10) Pub. No.: US 2005/0231298 A1
(43) Pub. Date: Oct. 20, 2005

(54) Nonreciprocal circuit element

(75) Inventor: Yuichi Shimizu, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/104,787

(22) Filed: Apr. 13, 2005

(30) Foreign Application Priority Data
Apr. 19, 2004 (JP) 2004-123066

(51) Int. Cl. H01P 1/32

(52) U.S. Cl. 333/1.1; 333/24.2

(57) ABSTRACT

A nonreciprocal circuit element includes a first yoke having an upper plate, a second yoke which has a flat lower plate and forms a magnetic closed circuit together with the first yoke, a flat ferrite member arranged between the upper plate and the lower plate, and first, second and third central conductors arranged to partially cross one another in a vertical direction via a dielectric. The dielectric and the central conductors are arranged on a top surface or a bottom surface of the ferrite member. A coil to which a direct current is applied is arranged at an outer circumference of the ferrite member, such that a direct current magnetic field is generated at the ferrite member by means of the coil. As a result, since a typical magnet is not required, a small nonreciprocal circuit element having the small number of components can be implemented at low cost.

### BACKGROUND OF THE INVENTION

1. Technical Field

The invention relates to a nonreciprocal circuit element, such as an isolator or a circulator, which is used in a transmission unit of a mobile communication apparatus such as a cellular phone.

2. Related Art

FIG. 5 is an exploded perspective view showing a nonreciprocal circuit element of the related art. A configuration of the nonreciprocal circuit element of the related art will now be described with reference to FIG. 5. A boxlike first yoke 51 includes a boxlike magnetic plate (steel plate or the like). The first yoke 51 has an upper plate 51a and a convex portion 51b provided on the upper plate 51a. A circular magnet 52 is provided in the first yoke 51.

A boxlike second yoke 53 includes a boxlike magnetic plate (steel plate or the like). The second yoke 53 is coupled with the first yoke 51 to form a magnetic closed circuit.

A winding 54 is provided between the upper plate 51a and the magnet 52, such that the winding 54 is arranged at an outer circumference of the convex portion 51b of the first yoke 51.

A circular ferrite member 55 is arranged on a lower plate 53a of the second yoke 53. In addition, a central conductor 56 is arranged on the ferrite member 55 and capacitors 57 are connected to the central conductor 56.

In the nonreciprocal circuit element of the related art having the above-described configuration, an operating magnetic field of the ferrite member 55 is changed depending on whether or not a current is applied to the winding 54, so that an operating frequency is changed.

However, since the nonreciprocal circuit element of the related art needs the magnet 52, in addition to the winding 54, so as to change the operating frequency, the number of components becomes large. As a result, a manufacturing cost of the nonreciprocal circuit element increases. Further, a small nonreciprocal circuit element is hardly achieved.

As described above, according to the nonreciprocal circuit element of the related art, there is a problem in that since the magnet 52 is needed, in addition to the winding 54, so as to change the operating frequency, the number of the components becomes large. Accordingly, the manufacturing cost thereof increases. Further, the small nonreciprocal circuit element is hardly achieved.

### SUMMARY OF THE INVENTION

Accordingly, it is an object of the invention to provide a small nonreciprocal circuit element having the small number of components at low cost.

According to a first aspect of the invention, there is provided a nonreciprocal circuit element including a first yoke having an upper plate, a second yoke which has a flat lower plate and forms a magnetic closed circuit together with the first yoke, a flat ferrite member arranged between the upper plate and the lower plate, and first, second and third central conductors arranged to partially cross one another in a vertical direction via a dielectric. The dielectric and the central conductors are arranged on a top surface or a bottom surface of the ferrite member. A coil to which a direct current is applied is arranged at an outer circumference of the ferrite member, such that a direct current magnetic field is generated at the ferrite member by means of the coil.

Further, in the first aspect of the invention, it is preferable that the ferrite member has first and second ferrite bodies, the dielectric and the central conductors are arranged between the first and second ferrite bodies, and the coil is arranged at an outer circumference of at least one of the first and second ferrite bodies.

Further, it is preferable that the coil is provided over the first and second ferrite bodies.

Further, it is preferable that the dielectric and the central conductors are integrated to form a block body.

Further, it is preferable that the dielectric and the central conductors are provided on one surface of the ferrite member.

Further, it is preferable that the dielectric and the central conductors are provided on any one of the first and second ferrite bodies.

### BRIEF DESCRIPTION OF THE DRAWINGS

FIG. 1 is a cross-sectional view showing essential parts of a nonreciprocal circuit element according to a first embodiment of the invention;

FIG. 2 is a perspective view of a ferrite member and a dielectric in the nonreciprocal circuit element according to the first embodiment of the invention;

FIG. 3 is a cross-sectional view showing essential parts of a nonreciprocal circuit element according to a second embodiment of the invention;

FIG. 4 is a perspective view of a ferrite member and a dielectric in the nonreciprocal circuit element according to the second embodiment of the invention; and

FIG. 5 is an exploded perspective view showing a nonreciprocal circuit element of a related art.

### DESCRIPTION OF THE PREFERRED EMBODIMENT

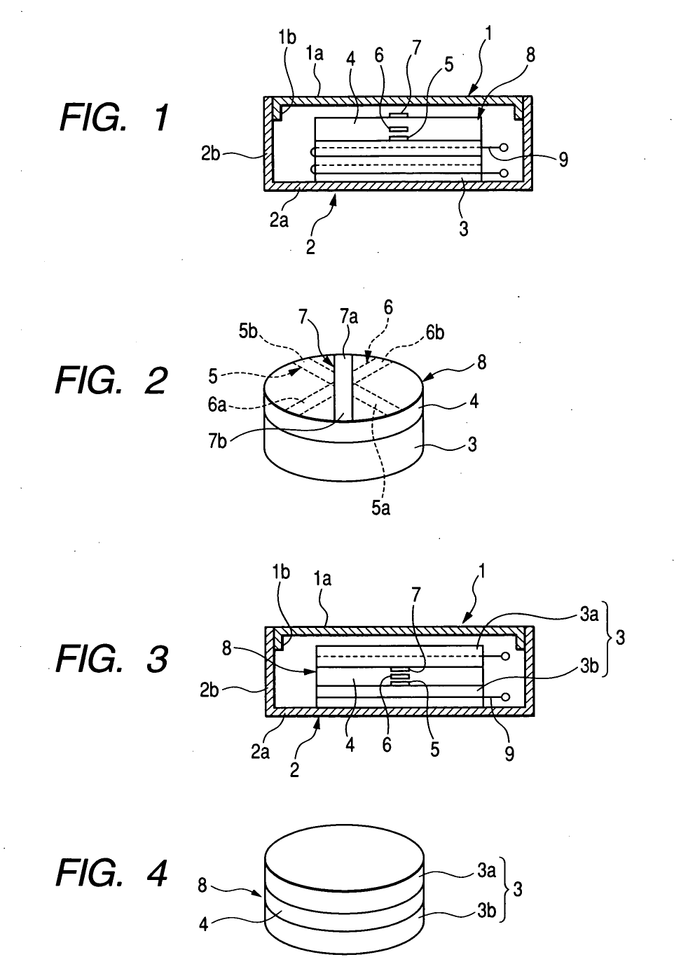

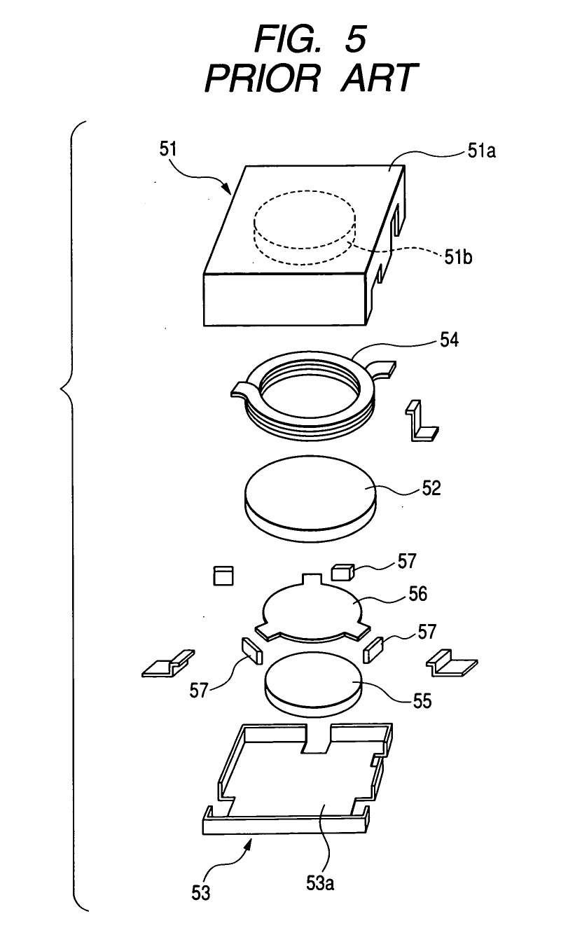

A reciprocal circuit element of the invention will now be described with reference to the accompanying drawings. FIG. 1 is a cross-sectional view showing essential parts of a nonreciprocal circuit element according to a first embodiment of the invention. FIG. 2 is a perspective view of a ferrite member and a dielectric in the nonreciprocal circuit element according to the first embodiment of the invention. FIG. 3 is a cross-sectional view showing essential parts of a nonreciprocal circuit element according to a second embodiment of the invention. FIG. 4 is a perspective view of a ferrite member and a dielectric in the nonreciprocal circuit element according to the second embodiment of the invention.

Next, the configuration of the nonreciprocal circuit element according to the first embodiment of the invention will be described with reference to FIGS. 1 and 2. A boxlike or U-shaped first yoke 1 is made of a magnetic plate (steel plate or the like). The first yoke 1 includes an upper plate 1a having a rectangular shape and side plates 1b bent downward from both ends of the upper plate 1a.

A boxlike or U-shaped second yoke 2 is made of a magnetic plate (steel plate or the like). The second yoke 2 includes a lower plate 2a having a rectangular shape and side plates 2b bent upward from both ends of the lower plate 2a. The side plates 1b of the first yoke 1 are coupled with the side plates 2b of the second yoke 2 to form a magnetic closed circuit.

A disc-shaped ferrite member 3 is made of YIG (yttrium iron garnet). On the ferrite member 3, first, second and third central conductors 5, 6, and 7 are arranged to partially cross one another via a dielectric 4.

In addition, the dielectric 4 and the first, second and third central conductors 5, 6, and 7 are integrated as one component to form a block body 8. For example, the block body 8 is obtained by forming the dielectric 4 and the first, second and third central conductors 5, 6, and 7 on an upper surface of an insulating substrate (not shown) made of low temperature cofired ceramics (LTCC) or resin by means of thin film techniques, such as deposition methods or sputtering methods, or thin film techniques, such as printing or coating.

In addition, as materials for the dielectric 4, silicon nitride, barium titanate, lead titanate, and the like may be used, irregardless of a thin film or a thick film. In addition, as materials for the first, second and third central conductors 5, 6, and 7, in a case of a thin film, silver or aluminum may be used and, in a case of a thick film, silver paste or silver-palladium paste may be used.

In addition, the dielectric 4 and the first, second and third central conductors 5, 6, and 7 may be directly formed on one surface of the ferrite member 3 by means of thin film techniques, such as deposition methods or sputtering methods, or thin film techniques, such as printing or coating. The dielectric 4 and the first, second and third central conductors 5, 6, and 7 may be integrally formed on the ferrite member 3.

In addition, the block body 8 is arranged on the ferrite member 3 and is fixed to the ferrite member 3 by means of an adhesive.

Moreover, the dielectric body 4 and the first, second and third central conductors 5, 6, and 7 may be arranged on a bottom surface of the ferrite member 3.

A coil 9 is formed by winding a metal line and is arranged at an outer circumference of the ferrite member 3.

The coil 9 may be directly wound at the outer circumference of the ferrite member 3 or the ferrite member 3 may be arranged in a hollow portion of the coil 9 formed by winding the metal line. In addition, the wound coil 9 may be formed on a bobbin (not shown) and the ferrite member 3 may be arranged in a hollow portion of the bobbin.

In addition, the first, second and third central conductors 5, 6, and 7 have port portions 5a, 6a, and 7a disposed at one ends, respectively, and have ground portions 5b, 6b, and 7b disposed at the other ends, respectively. Although not shown, the port portions 5a, 6a, and 7a are connected to capacitors or resistors, and the ground portions 5b, 6b, and 7b are grounded to the second yoke 2 or the like.

In the nonreciprocal circuit element having the above-described structure, when a direct current is applied to the coil 9, a direct current magnetic field is generated at the ferrite member 3, so that the ferrite member 3 functions as a magnet. Accordingly, an operating frequency of an isolator or circulator is obtained.

In addition, the ferrite member 3 is made of YIG which is a soft magnetic material (a magnetic material to be relatively easily magnetized or demagnetized). Then, if a current flowing in the coil 9 is changed, a magnetic force can be immediately changed and thus the operating frequency can be changed in a short time. In addition, since YIG has high transmittance, even though the size is small, a strong magnetic field is obtained. As a result, YIG is suitable for miniaturization.

In addition, a nonreciprocal circuit element according to a second embodiment of the invention will be described with reference to FIGS. 3 and 4. According to the second embodiment, a ferrite member 3 has two ferrite bodies 3a and 3b. In addition, a dielectric 4 and first, second and third central conductors 5, 6, and 7 are arranged between the first and second ferrite bodies 3a and 3b. A coil 9 is wound at an outer circumference of one or both of the first and second ferrite bodies 3a and 3b.

In addition, similarly to the first embodiment, in the second embodiment, a block body 8 may be arranged between the first and second ferrite bodies 3a and 3b, so that the block body 8 and the first and second ferrite bodies 3a and 3b are integrally formed. Alternatively, the dielectric 4 and the first, second and third central conductors 5, 6, and 7 may be integrally formed on one of the first and second ferrite bodies 3a and 3b by means of the thin film techniques, such as the deposition methods or sputtering methods, or the thin film techniques, such as printing or coating.

Other elements are the same as those of the first embodiment. The same elements as those of the first embodiment are represented by the same reference numerals and the descriptions thereof will be omitted.

In the second embodiment, the thickness of each of the first and second ferrite bodies 3a and 3b is equal to the thickness of each of parts when the ferrite member 3 in the first embodiment is bisected. In addition, the first, second and third central conductors 5, 6, and 7 are arranged between the first and second ferrite bodies 3a and 3b. Therefore, a uniform magnetic flux in a vertical direction can be obtained and the isolation in the operating frequency (a difference between a loss when a signal propagates in a forward direction and a loss when the signal propagates in a backward direction) can be increased.

The nonreciprocal circuit element of the invention includes a first yoke having an upper plate, a second yoke which has a flat lower plate and forms a magnetic closed circuit together with the first yoke, a flat ferrite member arranged between the upper plate and the lower plate, and first, second and third central conductors arranged to partially cross one another in a vertical direction via a dielectric. The dielectric and the central conductors are arranged on a top surface or a bottom surface of the ferrite member. A coil to which a direct current is applied is arranged at an outer circumference of the ferrite member, such that a direct current magnetic field is generated at the ferrite member by means of the coil. Therefore, since the typical magnet is not required, a small nonreciprocal circuit element having the small number of components can be provided at low cost.

In addition, when the current flowing in the coil is changed, a magnetic force can be immediately changed, so that an operating frequency can be changed in a short time.

Further, the ferrite member has first and second ferrite bodies, the dielectric and the central conductors are arranged between the first and second ferrite bodies, and the coil is arranged at an outer circumference of at least one of the first and second ferrite bodies. Therefore, a uniform magnetic flux in the vertical direction can be obtained and the isolation in the operating frequency (a difference between a loss when a signal propagates in a forward direction and a loss when a signal propagates in a backward direction) can be increased.

Further, the coil is provided over the first ferrite bodies. Therefore, a magnetic flux density generated at the first and second ferrite bodies can be stabilized. As a result, a nonreciprocal circuit element having superior performance can be obtained.

Further, the dielectric and the central conductors are integrated to form a block body. Therefore, the dielectric and the central conductors can be more easily assembled into the ferrite member. As a result, a nonreciprocal circuit element having excellent productivity can be obtained at low cost.

Further, the dielectric and the central conductors are formed on one surface of the ferrite member. Therefore, the thickness of the nonreciprocal circuit element can be thinned. As a result, a small nonreciprocal circuit element can be obtained.

Further, the dielectric and the central conductors are formed on any one of the first and second ferrite bodies. Therefore, the thickness of the nonreciprocal circuit element can be thinned. As a result, a small nonreciprocal circuit element can be obtained.

1. A nonreciprocal circuit element comprising:
a first yoke having an upper plate;
a second yoke which has a flat lower plate and forms a magnetic closed circuit together with the first yoke;
a flat ferrite member arranged between the upper plate and the lower plate; and
first, second, and third central conductors arranged to partially cross one another in a vertical direction via a dielectric,
wherein the dielectric and the central conductors are arranged on a top surface or a bottom surface of the ferrite member, and
a coil to which a direct current is applied is arranged at an outer circumference of the ferrite member, such that a direct current magnetic field is generated at the ferrite member by means of the coil.

2. The nonreciprocal circuit element according to claim 1,
wherein the ferrite member has first and second ferrite bodies,
the dielectric and the central conductors are arranged between the first and second ferrite bodies, and
the coil is arranged at an outer circumference of at least one of the first and second ferrite bodies.

3. The nonreciprocal circuit element according to claim 2,
wherein the coil is provided over the first and second ferrite bodies.

4. The nonreciprocal circuit element according to claim 1,
wherein the dielectric and the central conductors are integrated to form a block body.

5. The nonreciprocal circuit element according to claim 1,
wherein the dielectric and the central conductors are provided on one surface of the ferrite member.

6. The nonreciprocal circuit element according to claim 2,
wherein the dielectric and the central conductors are provided on any one of the first and second ferrite bodies.
